(19) United States
(12) Patent Application Publication
(10) Pub. No.: US 2017/0187520 A9
(43) Pub. Date: Jun. 29, 2017

(54) Secure data interchange of biochemical and biological data in the pharmaceutical and biotechnology industry

(71) Applicants: Frederick S.M. Herz, Warrington, PA (US); Bhupinder Madan, Basking Ridge, NJ (US)

(72) Inventors: Frederick S.M. Herz, Warrington, PA (US); Bhupinder Madan, Basking Ridge, NJ (US)

(21) Appl. No.: 10/421,618

(22) Filed: Apr. 22, 2003

Related U.S. Application Data
(63) Continuation-in-part of application No. 10/357,843, filed on Feb. 3, 2003, now abandoned.
(60) Provisional application No. 60/373,831, filed on Apr. 22, 2002.
(60) Provisional application No. 60/353,111, filed on Feb. 1, 2002.

(51) Int. Cl. G06F 19/00; H04L 9/00

(52) U.S. Cl. CPC H04L 9/0805; G06F 19/00

(57) ABSTRACT

A secure data interchange will allow pharmaceutical and biotechnological interests to securely share and profit from biochemical and biophysical data. The purpose of the interchange is to maintain the proprietary value of such data by guarding its exposure to other users while allowing some of its scientific value to be passed along. Specifically, users submit data in conjunction with, and conditional upon, various rules and conditions of use. The system itself, as a trusted third party, is supported by a diverse set of human and machine experts. When productive correlations and complementarities in different users' interests or data are detected, the information is passed back to the users in accordance with the desired level of transparency. Automated means are provided for data matching and selective determination of which particular data to release and to whom in view of the data's conditions of use ascribed. Efficient market exchange mechanisms are explored.

### CROSS REFERENCE TO RELATED APPLICATIONS

### U.S. Patent Documents

| | | | | |
|---|---|---|---|---|
| 6553317 | April, | 2003 | Lincoln, | et al |
| 6363399 | March, | 2002 | Maslyn, | et al |
| 6110426 | August, | 2000 | Shalon, | et al |
| 5970500 | October, | 1999 | Sabatini, | et al |
| 5953727 | September, | 1999 | Maslyn, | et al |
| 5840484 | November, | 1998 | Seilhamer, | et al |
| 5706498 | January, | 1998 | Fujimiya, | et al |
| 5523208 | June, | 1996 | Kohler, | et al |
| 5418944 | May, | 1995 | DiPace, | et al |

### RELATED U.S. APPLICATION DATA

Continuation in part to patent Pending application entitled “Secure Data Interchange”, Herz, et al.

### REFERENCE TO SEQUENCE LISTING, A TABLE

Descriptive title of the invention page—page 1
Cross Reference to Related Applications—page 1
Field of the Invention—page—2
Background of the Invention—page—2
Brief Summary of the Invention—page—4
Brief Description of the Drawing—page—6
Detailed Description—page—6
Abstract—on a separate sheet of paper
Claim—on a separate sheet of paper

### FIELD OF THE INVENTION

The field to which the present invention relates and impacts include the pharmaceutical, biotechnology and bioinformatics industries and more specifically, the drug discovery, biomolecular modeling, proteomics and genomics technical and commercial domains.

### BACKGROUND OF THE INVENTION

The drug discovery process is a long and arduous undertaking that requires huge amounts of finances for the successful completion of a project. To safeguard their substantial investments, pharmaceutical companies typically surround their research and development with high levels of secrecy. Although it is clear that such policies will protect a company's research portfolio, it is also evident that any synergies with outside parties' research will be completely lost. Although scientific process is generally facilitated by the sharing of knowledge and resources, in this particular domain there is very little incentive to do so because of the inherent value of the proprietary data. Historically, part of the cultural mentality of the pharmaceutical industry to assume an extremely possessive and proprietary interest in their bioinformatics firms' data which is due, in part, to the following factors.

1. This data, if associated with a blockbuster drug, could potentially be one of primary factors in the success of the drug company. The protection of this data could preserve the necessary critically essential lead-time it takes for a direct competitor to develop a competing product. Thus, in a nutshell, the combination of the investment in time and cost of new pharmaceutical agents and the extremely great emphasis on the proprietary value of the associated intellectual property in the acquisition and control of market share and in precluding competitors through the barrier of entry to this market share consists of the control of this intellectual property and maintaining its secrecy in order to help maintain a lead time market advantage.

2. The fact that biomolecular and proteomic modeling, protein pathway simulation and a host of other “in silico” experimental modeling techniques (which augment traditional purely experimentally based laboratory methods) are relatively nascent technologies to which the explosive growth of the biotechnology field can be attributed. The fact still remains that, until the relatively recent past these computerized modeling, analysis and experimentation simulation software tools have not been utilized in the laboratories of pharmaceutical companies actively engaged in the drug discovery process. However, for the very same reason that these techniques have been catalysts to the explosive expansion of bioinformatic data, the need and opportunity is ever more apparent to enable an efficient, automated, yet highly secure mechanism for exchanging the useful portions of these vast data reserves.

Hence, the current state of the industry is an ultimately inefficient one.

We propose a shared data interchange that will allow users to partially disclose data to each other in a manner that, on the one hand, safeguards the proprietary nature of the data, while on the other hand allows any potential cooperative benefits to be shared, bartered or sold between or among the users. In accordance with the latter two data exchange scenarios, such benefits could be “priced” or “appraised” by SDI according to the costs of the research that generated them or in another more appropriate/preferred variation, the opportunity costs associated with what the recipient would have had to invest independently in order to develop the data on their own. In this variation, such “investment” could include a combination of such interrelated variables as actual projected development cost, development time, time, and/or (SDI's) estimated value of the associated potential commercial opportunity for which the recipient plans to use that data (which may take into account both predicted upside opportunity and conversely, the downside risk). In the most ideal setting it would be easy to further envision SDI as an optimally efficient marketplace for data exchange in which the shared data interchange actually assumes the representative roles for both the independent/individual interests of each participating entity as well as (secondarily) the collective interests of all entities which belong to the interchange. In such an optimally efficient marketplace, for each exchange of data there would exist one SDI agent representing the seller and one representing the buyer, both buyer and seller agents negotiate the ultimate price of a given piece of data useful to the buyer. The buyer agent must trust the representations made about the data for sale, as presented to the seller agent. Because collusions and/or “price fixing” between different seller agents is illegal, multiple independent seller agents may bargain against one another, in order to compete for the sale to the buyer agent (in much as such efficient markets are ultimately buyer-driven). Of course, if/when data is only available visa-vie one seller, the market becomes seller driven by default and thus subject to the direct one-on-one negotiations between the agents. In a paradigmatic sense the interchange may exist and function as separate proprietary “closed membership” sub-exchanges.

For example, in some situations a company will abandon or change a research program, in essence “orphaning” the data that was generated by the discontinued research. In such cases, the data could be shared, for a fee or other considerations, with other companies. While this would not reveal the current course of the company's research (as would be often mandated), it would somewhat compensate the company for the costs of the abandoned project.

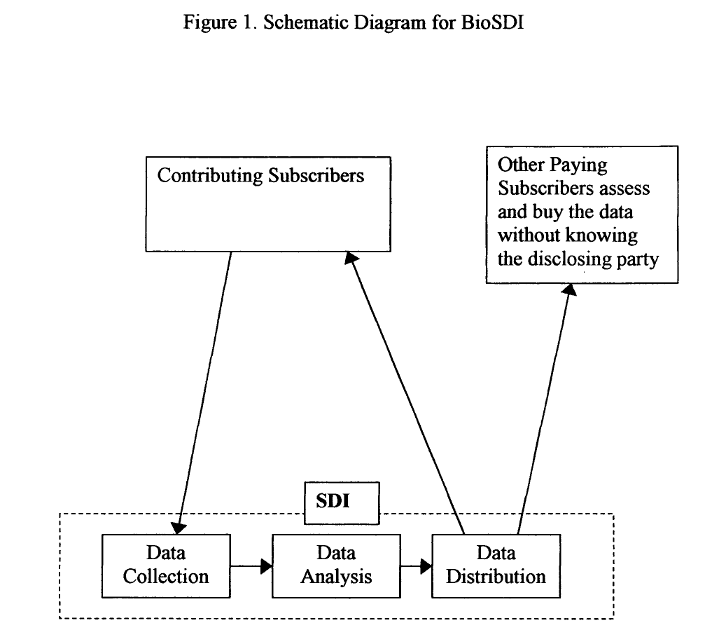

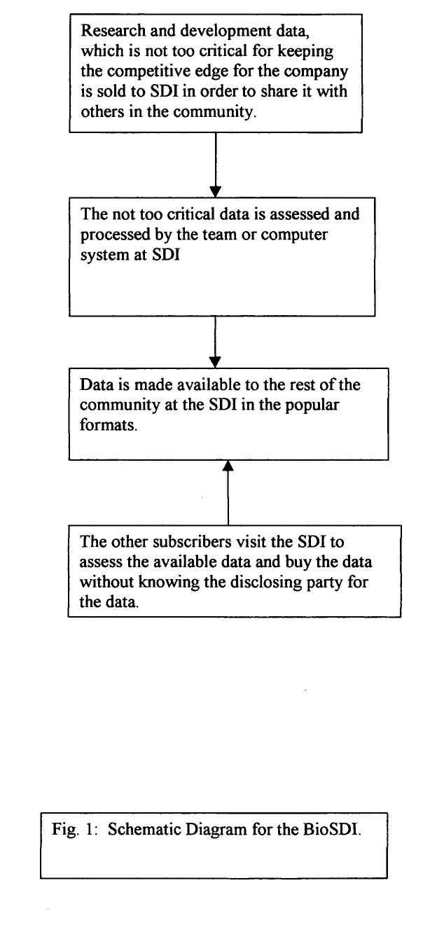

The shared data interchange works in the following fashion—scientists or companies subscribing to the service are provided with a trusted third party (either a human or machine expert) to which they may submit any and all kinds of data, research ideas, mathematical equations, etc. At the time of submission, the users specify how the material is to be used and shared. As is well disclosed within the present disclosure's parent patent application entitled, “Secure Data Interchange” provides in exhaustive detail the fundamental secure data collection, storage, sharing and data release disclosure policy architecture of the presently disclosed system as well as various useful ideas regarding market driven economic models for a data exchange some of which are readily extensible to the present context of a BioSDI market place. Accordingly, we hereby incorporate by reference the above identified parent patent application. The Shared Data Interchange is equipped with all of the data modeling tools utilized by the disclosers of the data itself in its modeling and formulation (to which SDI also has privileged access). When multiple users have submitted the data to the trusted party, the trusted party compares the material and assesses it for possible profitable trades with the other subscribers. The Secure Data Interchange then identifies the potential subscribers who would benefit from the data and informs them of the availability of the data. The Secure Data Interchange processes the data according to the needs of the original owner of the data and then passes the processed data to the other interested subscribers. For the benefit of validation and enforcement of trust, SDI may, if desired, also send the sender a copy of the data sent to the recipient along with the conditions required of SDI by the sender describing the criteria for restricting certain levels of deterministic or statistical information associated with the data. A schematic diagram of the Secure Data Interchange is shown in FIG. 1.

### BRIEF SUMMARY OF THE INVENTION

The technical and design objectives expressedly addressed by the problem statement of BioSDI relate to a privacy-protected market environment for data exchange among multiple self-interested parties where their privacy objectives can be objectively and securely met while at the same time optimal value of their data can be leveraged and harnessed in accordance with prescribed rules and conditions as provided by the disclosing organization and/or with its full knowledge and consent. Of critical importance is the fact that the system's inherent information selection, analysis, profiling and conditionally selective targeted disclosure to third parties are all performed within a carefully controlled, privacy assured environment. Because large collections of data can often be used as a potentially valuable resource in many problems and circumstances (for which the field of bioinformatics is no exception) as a part of the preferred embodiment, we propose a central data warehouse that maintains data by different organizations and executes queries, analytics and modeling functions on the data. In its data clearing house role, BioSDI executes and enforces rules based conditions provided by each disclosing organization are associated with information that define data which can be released under what conditions and to whom, for example, the likelihood of interest in competitive use of that data with respect to the disclosing party and the degree of inability of the associated recipient organization to extrapolate potentially sensitive (i.e., restricted) pieces of data from the data slated to be disclosed based upon the totality of previous privately disclosed data and that data which is publicly available. Different means may be applied for restoring the acquisition of that data which is outside the data disclosure criteria of the discloser's confidentiality policy. In one important implementational variation, the discloser's confidentiality policy is designed to quantitatively define a maximum acceptable probabilistically determinable degree of confidence that the prospective recipient organization is able to extrapolate about the fact that a particular data parameter or set of parameters could, in fact, be determined by the recipient to be present and/or matches the true value(s) for that parameter(s) in accordance with inherently identifiable probabilistic correlations with that data. In this particular context the present system, in fact, functionally performs a type of cryptographic data security for which that data to be slated for release is able to be adaptively controlled and modified in accordance with the type and quantity of correlatable data which the recipient (is believed to) have possession of and from which it would be able to make certain probabilistically determinable deductions (much like that of the role of a cryptoanalyst).

### BRIEF DESCRIPTION OF THE DRAWING

A Schematic diagram of the functioning of the Secure Data Interchange is shown in FIG. 1.

### DETAILED DESCRIPTION

The success of BioSDI in making the data available to its participants will be based on the classification of the data in its database. The proposed interchange will attach a number of keywords to each set of data in consultation with the disclosing party. These keywords will assist in storing as well as retrieving the data. In addition to attaching the keywords, the data may be stored in various classes to begin with. These classes could be the various systems of study by the participants, the techniques used in obtaining the data, or the class of the data obtained itself. For example, the techniques used could provide data which may be probabilistic or deterministic in nature. Such classes could also assist the recipient in knowing if the data he/she is looking for would be useful to him/her or not. Criteria for acquisition of data through the interchange may be performed either via manual or automated techniques (i.e., as a persistent set of queries) which in the latter case SDI also acts separately on behalf of the present recipient to seek out and identify available data as currently possessed by the interchange's pool of participants which is determined to be able to add potential value to the recipient, which, in turn, can be achieved in a plethora of different manual and automatic ways. In one example scenario, in the sharing of interaction parameter data, the potentially complementary data may:
1. Match the criteria for statistical similarity as measured by statistical similarity of the newly identified data to that of the present entity's preexisting data, thus representing the ability to improve or refine the quality of existing data possessed by that entity; for example, such improvements could quantifiably enhance the quality and rigor of the methods used in the supporting research work substantiating the model of that data, or the quantity of relevant data statistics as collected which were used in the creation of the models for that data.
2. Or, complementarily “adds to” the detail or completeness of the present entity's (prospective recipient's) data model used to achieve its desired objectives.
3. Data needs which represent active research endeavors of present interest and priority for the present entity's current laboratory research projects (perhaps which may be explicitly defined and submitted to SDI).

The techniques used for identifying complementary data from among the plethora stored within SDI (as would be applicable to items 1 and 2 above) may often be able to be performed based upon a methodology which is very similar to that of pattern matching techniques in which the search and matching process used to identify data “similarity” may be automatically adjudged in accordance with multiple similar and accordingly similarly weighted attributes (occurring among two or more disparate data sets) whose relevancy (relative weighting) value of each attribute is determined by particulars of the specific data of interest which is associated with the statistical model. (SDI can efficiently perform this task as it possesses both data parameters and the specific tools/modeling techniques used in the formulation and processing of those data parameters).

Depending on the type of data being shared, the disclosing user may place a series of preconditions on how data is to be given out. It will often be the case that parts of the data will be obscured such that proprietary aspects of the disclosers' own work will not be revealed. BioSDI will contain statistical tools capable of analyzing and reporting back to the discloser how risky a given level of obscurity will be, before the discloser actually releases the data to the network. Several examples of potentially relevant parameters which may be useful predictors of the various data obscurity parameters are suggested below under “Methodology”.

Accordingly, one preferred implementation prescribes, well in advance of disclosure, certain desired thresholds which define quantitatively a level of risk (i.e., for purposes of the present system, a quantitative measure of “indistinguishability” from other “similar” biological systems) (e.g., relating to the present molecule, metabolic pathway, cell type or class of physiological effects to which the presently disclosed data relates). In this latter application, the discloser may pre-specify data security conditions for disclosure. (The term “indistinguishability” may be used interchangeably with “obscurity”).

### EXAMPLE

Suppose that a data-providing user specifies and releases complete atom-atom interaction data for a part of a molecule “A” in a cell target “B” participating in a metabolic pathway “C”. Taking into account currently available models, the most that a recipient might be able to infer about the overall structure would be that it contains a specified number of atoms in the disclosed portion of the molecule or unrelated part of the molecule (for example) and that these atoms may relate to a W number of currently known molecules participating in X other significant molecular pathways, and that there may exist Y number of further “significantly” recognized reactions for each of these pathways and that there are Z number of other potential significantly recognized protein molecules to which that molecular segment could just as easily constitute a portion of. Certainly, it is easy to assume that if the length of a particular molecular segment is shortened (e.g., by even only one atom) that the indistinguishability (obscurity) of that segment will increase significantly (non-linearly) to the percent reduction of the segment. Of course, by far the most significant obscurity enhancing effect is achieved by removal of the relatively unique portions of a molecule, which are most prevalent parts of a biochemical reaction. Although other relevant variables are applicable such as which portion of the molecule, its structural uniqueness (within all plausible or likely other possibilities in light of the total data possessed by the recipient, etc.) Thus this latter technique constitutes an important part of the role of Bio SDI in maximizing shared value exchange while attempting to greatly minimize the effect of enhancing the dissemination of data which could be used as an end objective by the recipients which are potentially directly competitive to the disclosing organization for potentially directly competitive end-objectives. In addition, as the range/variety and total pool of bioinformatic information continues to grow (and at an ever accelerating rate the inherent indistinguishability (obscurity) of any given piece of data will also increase plausibly according to a relatively linearly correlated relationship) Given the presently known range of pathways, protein structures and potential interactions of significance, the discloser's ultimate objective is to achieve a quantified set of prescribed (or pre-disclosed) conditions (a minimum level of satisfaction) such that outside of such quantified conditions or constraints it is impossible for the recipient to make statistical inference as to presence of statistical likelihood of that segment or parameter(s) to be associated with (or part of) a particular parameter, a particular pathway or a protein molecule with which the present segment is associated by making it indistinguishable from X number of potential alternatives (within a maximum limit of statistical probability).

Selection of the particular parameters which are truly relevant reasonably reliable predictors of indistinguishability (or obscurity) parameters are at best tricky involving complexity in the parameters and are likely to be variable depending upon the type of structural and interaction-based parameters associated with the specific data contained within the present data model. A few suggested (reasonably plausible) possible parameters are disclosed in the following section (“Methodology”). Accordingly from the standpoint of the methodology itself which is used to estimate these various obscurity values because the data modeling algorithm of choice by the discloser also utilized for the modeling/creation of the actual data as disclosed, it is reasonable to certainly use the same statistical algorithm as well as other modeling algorithms (which may possess other strengths/advantages in determining accuracy of the various parameters) provided that the algorithm is based upon a core statistical/earning technique. In this regard, the “unknown” parameters are the indistinguishability parameters (as above explained) and the input parameters are, of course, those known descriptive parameters relating to the structural/functional characteristics of the molecule, its interaction-based moieties and/or its associated as well as the parameters which are “predictors” of indistinguishability” (such as those suggested in items a-g in the following section), which may in some cases require the additional capture and correlation of parameters to the basic modeling parameters and which are not typically critically required within the data modeling scheme which is used for the present experimental objectives.

In some cases, rather than simply hiding information, a user may wish to make use of “randomized aggregates” to add noise to the data being disclosed. In such a case, the aggregate properties of a collection of objects will be preserved (for example, mean value), but individual items within the collection will not be fully accurate representations of the underlying data.

The technical details explaining the mathematical theory of randomized aggregates is disclosed in co-pending patent application entitled “Secure Data Interchange.” Among many useful applications for randomized aggregates within the present system context is the use of the presently described statistical framework or “interaction moieties” in which it may be desirable to obscure not only the individual directly interacting atoms or “interaction moieties”, but rather also the associated indirect multiple (neighboring) atoms (or molecular segment(s) associated with that interaction. Invariably, the vast majority of the distinguishing structurally “unique” features of any given sequence in a molecule when compared to the sum of all other very similar sequences found in other molecules (most likely) have very little functional influence on a given interaction in and of themselves. The square of the number of these unique features (roughly the length of a given molecular segment, which is disclosed) is inversely proportional to the level of overall obscurity. As a consequence, in yet another (third) variation of randomized aggregates, it could be advantageous to the disclosing party to limit the information disclosure to a particular segment by excluding or subtracting the indirectly induced interaction effect emanating from any additional atoms outside of that segment whose (indirect) interaction parameters could be revealing of associated information about specifics of those atoms inducing those secondary interaction effects.

### Methodology for Deriving and Implementing Statistical Measures of Obscurity of Disclosed Data

The proposed methodology for deriving various critically important parameters in order to determine a variety of key measures of statistical obscurity, can only function with some predictable and reliable level of accuracy, if and only if
a) A plethora of attributes are tested repetitively across a variety of types of actual biochemical data and against a “hacker” using a statistical model to derive the actual data the discloser is attempting to conceal by virtue of the proposed methodology's steganographic and cryptographic advantages.
b) These attributes are deliberately selected by human experts knowledgeable in the field.

In the following we provide a number of attributes, which determine the degree of obscurity of the disclosed data from the data on hand. The attributes provided are described using a particular kind of data, however, these attributes are not limited to a particular style of data. In fact, a similar set of attributes could be determined which would be applicable to an altogether new class of biochemical data. Several examples of attributes, which may statistically relate and thus be predictive of some of the useful and important obscurity parameters as suggested in the above example include the following (note the pre-qualifying terms “directly proportional to” and “inversely proportional to” are stated simply for exemplification purposes):
1. The degree of obscurity is likely to be inversely proportional to the following parameters:
a) Data quantity within the domain of that particular biochemical pathway and its degree of similarity to that possessed by the recipient prior to receipt, specifically:
   i. The amount of existing data that the disclosee (recipient) has in its possession a priori regarding that type of molecular interaction as well as:
   ii. The degree of “similarity” that these data models share with the present data model being disclosed. (In this latter, regard, SDI may be able to act as a trusted “auditor” in terms of verifying all of the information which it had previously disclosed to that receiving party and possibly the data, which that party had independently created, so as to appropriately adjust the degree of obscurity relative to the recipient prior to disclosure of the data in this manner).
b. Precision and uniqueness specifically:
   i. The number and degree of precision (e.g., quantifiable numerical value) of the physical and chemical parameters associated with the atomic interaction model.
   ii. The degree of novelty or uniqueness of the associated physical and chemical parameters (more precisely, the novelty of the combinatorial pattern of these parameters) assuming that the recipient's data model correlations of these parameters inherently possesses “statistical confidence”.
   iii. The degree of “commonality” of the physical and chemical parameters (i.e., their combinatorial patterns) assuming statistical confidence in the above correlation are absent.
   iv. The present degree of popularity within the field's overall research initiatives and degree of precision (e.g., quantifiable numerical value) of the chemical parameters associated with the atomic interaction model.
c. Precision and uniqueness of interaction parameters specifically:
   i. The number and degree of precision (e.g., quantifiable numerical value) of the interaction parameters associated with the molecular/molecular interaction model.
   ii. The degree of novelty or uniqueness of the associated interaction parameters (more precisely, the novelty of the combinatorial pattern of these parameters) assuming that the recipient's data model correlations of these inherently possesses “statistical confidence”.
   iii. The degree of “commonality” of the interaction parameters (i.e., their combinatorial patterns) assuming statistical confidence in the above correlation is absent.
d. Quantity of data describing molecular structures within a biochemical pathway and degree of structural transformation of a molecule's precursors within a pathway specifically:
   i. The number of steps in a given biochemical pathway,
   ii. The degree of net structural change, which occurs within the molecule and/or its target.
   iii. The degree of statistical novelty (relative to the recipient's collective data) of the structural features, which characterize these disclosed molecule segments.
e. Number/complexity of molecular structure; specifically: the number of additional “neighboring” atoms (in their proper structural orientation/relationship), which are disclosed in conjunction with each single atom-atom interaction parameter (and, if relevant, associated physical and chemical parameters).
f. Assuming that both the prospective recipient and the data slated for delivery relate to the cell target (as opposed to a proposed targeting molecule), the number, of related cell targets (within a family) which are molecularly similar enough so as to be likely to interchangeably interact biochemically with an associated targeting molecule designed to target one of them.
g. The number, of related cell targets (within a family) for which only one interacts with the associated targeting molecule.

The number of biochemically/structurally similar targets which are known and modeled by the prospective data recipient as well as among these, the number of structurally similar targets which are presently known to be similar to those with which the ultimately desired targeting molecule under development is designed to interact (these of course would necessarily be entrusted with SDI).
2. The degree of obscurity is directly proportional to:
a) The degree of error, which is selectively added to the molecular interactions or the correlations between the molecular interactions and the chemo-physical parameters (as exemplified above). (so as to ultimately minimize degree of error while maximizing degree of obscurity.
b) The number, of related cell targets (within a family) for which these multiple targets each interact (to some desirable extent) with the associated targeting molecule.

It is worth emphasizing that it is extremely advantageous for optimizing this degree of obscurity to only reveal INDIVIDUAL atom-atom interactions whose direct interaction parameters are influenced by other neighboring atoms but whose associated identities are concealed; it could, for example, be possible to state along with the disclosure the isolated individual atom-atom interaction parameters (as if in a vacuum) and only if the recipient is working with those atoms within the context of the same neighboring atomic structures would the appropriately modified interaction parameters become revealed (inasmuch as they, in turn, also affect and are affected by these neighboring similar structures). Of course, even so, this more extensive data revelation is predicated upon the condition that the totality of recipient data following disclosure results in the recipient remaining within the obscurity threshold as prescribed by the original discloser as exemplified in the above example.

### Pricing

Once BioSDI detects useful correlations between particular sets of data, it contacts those users who might benefit from the information. If they are interested in making use of the offered data, and agree to the terms of disclosure (which determine the final form of the data that they will receive), the system brokers an exchange. In short, the receivers get the data and the provider gets a payment. There are obviously many different ways that the price for this exchange could be determined and it is likely that a variety of modalities for the exchange which co-exist together (or even could be used to create hybrid forms of payment for a given transaction) would provide an overall advantage to the system:

1) Swaps—If both parties own data that is potentially useful to the other, they can simply trade the data with each other.
2) Fixed payment—The provider assigns a pre-determined price to the data before it is submitted to the system. The provider then receives this amount each time a user accesses the data.
3) Value-Based Pricing—BioSDI uses its proprietary knowledge of a potential purchaser in conjunction with statistical models to forecast the marginal benefit of a given piece of data. Because BioSDI serves as an impartial marketplace, it splits the surplus between the buyer and the seller.
4) Auction-based Pricing—In situations in which it is preferable for only one user to receive the data, BioSDI serves as an electronic auction house: it alerts users of the data's potential benefits, holds an auction, and sells the data to the highest bidder. The specific technical details explaining how an auction-based trading system is designed when the traded assets are clearly of a multi-dimensional nature (as they are in the present application) is disclosed in the Ph.D. thesis, “Iterative Combinatorial Auctions”, of David C. Parkes of the Computer Information Science Department at the University of Pennsylvania.

### Further Applications of BioSDI

BioShared Data Interchange would obviously offer to exchange data of various kinds which are important in the pharmaceutical and biotechnology industry community. The above example is one such kind. In the following we give a few examples of important classes of data which can easily be obscured enough to keep their proprietary value to the discloser.

a) Structural and Proteomics Data: Over the last three decades, the pharmaceutical and biotech industries have benefited greatly from advances made in X-ray crystallography, NMR techniques, mass spectrometry, and micro array techniques. Advances in computational methods have particularly helped in areas where it has been difficult to obtain reliable results from experimental work. This is especially true in the fields of computational biochemistry and biology. In spite of the enormous success of these new techniques in generating useful data, there are significant number of areas where the biochemical data sharing could be advantageous to the pharmaceutical industry. SDI provides a framework under which such information could be safely shared.
b) Interaction Parameters: Starting with the pioneer simulation of hard spheres, computer simulations of atoms and molecules have been important tools for almost four decades. They are now commonplace in the physical sciences, particularly in the fields of chemistry, biochemistry and biology. By simulating molecules of biological importance, scientists are able to study various biological reactions and predict various properties of individual biomolecules. Because these studies are hard to conduct experimentally, the computer simulations are especially important. In spite of a history of scientific success, these methods are still marked by certain inherent problems. For example, the underlying database used to simulate the atomic-level interactions between participating atoms still needs improvement. Because this set of interaction parameters is not entirely accurate, many of the molecular properties estimated by the simulations are not comparable to experimentally observed values. In this disclosure, we suggest that a secure data interchange could compare interaction parameters derived from a wide variety of different sources, combining them into more reliable estimates that could then be compared against experimentally derived values.
c) Protein Structures and Prediction Methods: In addition to direct molecular simulations, there are various other computational techniques popular among biochemists and biologists. The method for predicting the tertiary structure of proteins is such an example. Homology modeling uses the primary sequence of proteins to predict their tertiary structures. Neural networks are often used to accomplish this task. We suggest that if a large set of predictive methods and a large set of unpublished protein structures are shared in the interchange, it might lead to better predictive schemes as well as predicted structures for yet unsolved proteins. Many institutions should be able to share the unpublished data on protein structures without fearing a loss of proprietary value.
d) Drug Binding: Drug molecules bind to protein molecules; however, some of them bind to DNA as well. It is very important to understand the various aspects of this binding mechanism. One such aspect is the binding energy involved in the reaction of drug molecules to proteins. In this disclosure, we suggest that the secure data interchange provides a framework for storing and sharing data about drug molecules and the proteins they bind to.
e) Mass Spectrometric Data: Sharing mass spectrometric data obtained from various cell studies could assist in the determination of the secondary and tertiary structures of the hundreds of protein molecules involved in whole cells (as opposed to individual protein structures, which are determined in the laboratory by X-ray crystallographic methods). The thousands of pieces of information obtained from mass spectrometric methods applied to the cell components could be gathered at the shared data interchange, allowing more light to be shed on the regulatory functions of various proteins in the cells. More macro-level data modeling techniques and especially those which additionally choose to incorporate protein structure models could be particularly benefited by complementary share of these two types of data. In this type of model, integrating the presence of both types of parameters may often result in an overall enhancement (mutually) to all parameters of both types (i.e., secondary and tertiary structural and individual protein structural) parameters.

### Practical Implementational Considerations and Associated Value-Added Opportunities

Although the BioSDI system framework addresses a significant need within the field of bio-informatics, there will be nonetheless from a practical implementation standpoint admitted imperfections which once successfully addressed over time through improvements could eventually provide much greater efficiencies of scale such as more dynamical and more complex querying in a completely automated fashion the distributed data sharing paradigm which could be achieved through such system refinements as a common data format (among currently disparate heterogeneous data formats), common semantic protocols (as well as computer-mediated generation of the semantic representation of data created). Certainly the industry-wide agreement and associated acceptance of unified industry-wide common protocols relating to this presently proposed data sharing scheme would improve the efficiency and responsiveness of the system at a variety of levels in the data sharing process. BioSDI may (particularly in the interim) in addition, achieve certain (perhaps most) of these objectives through the use of similarly functioning middleware software in order to mediate these data conversions for purposes of communications between SDI and its associated participating constituent data sharing entities. One particularly intriguing future emergent paradigm in the field of bioinformatics for which these common data exchange protocols if used in conjunction with SDI could prove most valuable is the integration of embedded systems technology into the actual in vitro (and potentially even in vivo laboratory testing environments and associated data measurement and data collection instrumentation. Significant gains could effectively be achieved at a variety of levels including much faster data collection recording and processing as well as a significantly greater quantity of data most of which is currently either uncollected or discarded by presently used methodologies. However, by contrast, within the BioSDI framework the free flow of this data into BioSDI could enable real time centralized monitoring and dynamic detection of any and all useful pieces of data within the scope and context of the present (and continually updated) “needs criteria” for the overall data collection and processing needs of BioSDI in as much as it is able to be instead represented as such as a singular collective entity. Dr. Ed Lazowska, Department of Computer Science, University of Washington, in his Science Forum Lecture Series describes and refers to current research initiatives within this area of embedded systems for use within Biotechnology research, which is of noteworthy potential use and applicability to a BioSDI common data protocol based framework.

An additional value added benefit and opportunity which BioSDI enables is the opportunity to act in a “match making” capacity whereby, for example, substantially large data sharing procedures occurring through SDI may also suggest that the human experts involved in the original creation of such data may potentially also share in common a potential need and thus opportunity to collaborate in a direct literal sense on active research endeavors which they mutually share in common. Furthermore, if desired, such human experts may even wish to submit CVs of both present and past research activities and experience such that, subject to the proper conditions (of pricing and data disclosure policies), these additional professional profile based features may be further incorporated into the matching scheme in order to further improve the system's performance accuracy and range of matchmaking opportunities, thus more readily harnessing the value of such mutual opportunities where ever or whenever they happen to exist among various disparate entities. The issued grandparent application (U.S. Pat. No. 5,754,938) as well as the parent application (pending) entitled “Secure Data Interchange” explains in significant technical detail how such a “match maker” system is designed as well as the types of applications and autonomous communication functions it may be able to perform.

Other Non-Bioinformatics-Related Domains in which SDI Could Provide Value.

Although the presently disclosed preferred methodologies of the preferred embodiment (constituting the system and methods for bioinformatics secured data exchange are potentially extremely important within the context of facilitating the speed, efficiency and cost savings of bioinformatics in its crucial role towards the growth of the biotechnology field as a whole, there are nonetheless other application domains for which very similar methodologies and conceptual objectives of the presently disclosed system could be readily and very advantageously adopted (and which would be reasonably obvious to those skilled to the relevant particular domains to which the above methods could be adopted). It can be appreciated that although the chemical structures and lengths of pathways may differ from that of the primary embodiment of BioSDI as herein disclosed in detail, those skilled in the art within each of the various respective alternative fields of use could readily extend the methods used in the presently detailed bioinformatics exemplary application and the associated novel methods of BioSDI for confidentially disclosing, detecting and selectively sharing that portion of the modeled data which does not threaten to compromise the proprietary nature of sensitive data portions of those data models. Accordingly, it is abundantly clear to those skilled in the relevant parallel alternative fields of art that the presently proposed methodology is readily and reasonably extensible to these same parallel related fields without substantially departing from the novel and paradigmatically exemplified teachings of the presently disclosed primary embodiment of BioSDI. Some examples of these fields include: 1. Genomics and genetic engineering, 2. Biochemical (as well as chemical) engineering, (including the related field of industrial enzymatics), 3. Nanotechnology (including nanomolecular engineering), 4. Materials Science 5. General purpose research data sharing—Although it is an extremely ambitious goal, within the framework of the presently discussed techniques for common data classification/metadata, data format and semantic protocol development and evolution as above suggested, as well as the development of middleware designed to achieve similar end objectives, it is certainly a reasonable goal to eventually develop a general purpose research application domain for SDI in which researchers within disparate laboratory environments could use SDI to find other potentially complimentary research data to that which they are currently working on and either automatically share that data within the data disclosure constraints of the prospective disclosers or to identify the existence of such complementary data and, in turn, notify the associated disclosers and recipients of these complementary assets and thus prompt a negotiation process between the prospective discloser and recipient based upon price offered by the recipient against the amount and detail of data provided by the associated discloser (or such process with sufficient critical mass could be automated through the above suggested market based techniques used within BioSDI). Certainly in order for these negotiations to be most efficiently performed, it is most useful to utilize the totality of data disclosed compared to data received of each entity into the exchange in order to arrive at a “net balance” of asset value which each entity is able to provide to the exchange in the form of “credit”. In addition, it is worthy to note that depending upon the degree of value which an entity which a particular data asset is worth to a given recipient, and if a portion of this value as determined by SDI is presently withheld in accordance with the disclosers data disclosure policy, this additional marginal value as it would exist relative to the prospective recipient could accordingly be appraised and estimated by SDI. Based upon a detailed pricing policy provided by the prospective recipient beforehand most (or all) of the steps in the data exchange process including frequently matching, in addition to negotiation and transaction may occur in automated fashion. This negotiation process requires determination of the maximum price that the recipient would be willing to pay for data of a certain type. This pricing policy may be based upon such pricing policy criteria as such information regarding the particular pathway, receptor site and molecule) data quality (e.g., soundness of the techniques used in the experimentation/modeling procedures) and nature of the prospective recipient (e.g., is the recipient a present or possibly a potential competitor and if so, with relation to what specific type/domain of bioinformatics data. This information may be based upon BioSDIs privileged access to information about the specific activities and focused areas of effort of the prospective recipient (e.g., via explicit knowledge or as determined and estimated by the quantity of data actually produced and submitted to BioSDI within each family of molecules receptors, pathways, etc., and perhaps more indirect knowledge of the same as inferred indirectly from the specifics of pricing polices of the recipient for data disclosure and receipt. Of additional relevance in many cases to the recipient is the value that that particular data provides relative to that particular recipient itself. The measurement of this parameter is a bit tricky, but could likely be modeled and predicted with some reasonable degree of reliability and accuracy (e.g., via a multi-dimensional predictive statistical model such as K-means clustering. For example, 100% of the potential value to recipient is invariably based upon the relevancy of the very specific nature of the data relative to the collective commercial investment in research and development initiatives relating directly (and indirectly) to research objectives requiring the application of such data. What percentage of this overall potential value is realizable depends upon such variables (possibly the product thereof) as to what degree is the present data to be received relevant to such overall objectives and to what (percentile) degree does the addition of the present prospective data disclosure actually quantitatively constitute the overall potential value that this type of data is able to provide relative to the recipient. It is worthy to note that the quantity of pre-existing data specifically relevant to the particular item of specific interest (e.g., structure, pathway, etc.) reduces the marginal increased value to the overall “data value” of the system by approximately the inverse of the square of this quantity of pre-existing data (assuming both new and existing data are of equal quality. In addition, the degree of “remoteness” of the portion of data to be disclosed to the primary objective item(s) of value/interest to the recipient also has an exponentially diminishing effect on the value of any such associated data as well (which may be considered for “sale” to that recipient). Given all of the relevant parameters (which may include but is in no way limited per se to those suggested above) as indicated, it should be possible to reasonably predict the approximate value to a recipient that a given piece of data slated for prospective acquisition is likely to provide to recipient. Thus it is possible to determine (e.g., automatically via BioSDI) an appropriate pricing policy that is adaptive to not only the needs of the recipient but also the context of the margin of value that a given piece of data is able to provide in addressing that specific need. As such with the resulting capability to manage and implement not only data disclosure polices, but also pricing polices for both prospective disclosers and recipients in automated fashion, BioSDI is positioned to also perform automated negotiation procedures. The details of how such an automated negotiation process could be designed to function within the context of the present system (using either a single intermediary, i.e., BioSDI or two separate intermediaries, i.e., assigned representative agents of each of the negotiating entities) are disclosed in detail in the parent (pending patent application entitled “Secure Data Interchange” and are generally well understood within the relevant field of art. Dr. David Croson and Rachel Croson (professors at the Wharton School, University of Pennsylvania) have also done a substantial amount of research work and publications in this general area of agent-based automated negotiations and intermediary-based negotiations. Based upon a detailed pricing policy provided by the prospective recipient matched against additional data disclosure policy parameters which are “negotiable” subject to price by the prospective discloser, it may be possible for SDI to mediate further higher additional value based trades involving the revelation of data of a somewhat more explicit nature to potential beneficiaries than would otherwise occur without these additional qualifying criteria to the pricing policies of the discloser and recipient and the data disclosure policy of the discloser. As consistent with the general framework's preferred implementation across its various potential domains, the prospective recipient could also be introduced to the prospective discloser, if desired provided that such an introduction is compatible with the prescribed data disclosure policy of the data discloser. The advantage of such introduction being more detailed exchange of data at a conceptual and creative level as well as identifying the potential mutually advantageous opportunities which may inherently exist between the parties for collaborative research.

We claim:

1. A system and method for providing a closed, secure data communications and storage environment through which experimental and scientific data may be exchanged between different participating member organizations.
